(19) United States
(12) Patent Application Publication
(10) Pub. No.: US 2010/0166080 A1
(43) Pub. Date: Jul. 1, 2010

(54) VIDEO DISPLAY APPARATUS

(76) Inventor: Satoko MIKI, Tokyo (JP)

Correspondence Address: BIRCH STEWART KOLASCH & BIRCH, PO BOX 747, FALLS CHURCH, VA, 22040-0747, US

(21) Appl. No.: 12/625,109

(22) Filed: Nov. 24, 2009

(30) Foreign Application Priority Data
Dec. 26, 2008 (JP) JP2008-332495
May 28, 2009 (JP) JP2009-128830

(51) Int. Cl. H04N 7/12; H04N 5/66

(52) U.S. Cl. 375/240.25; 348/739; 375/E07.027; 348/E05.133

(57) ABSTRACT

There is provided a video display apparatus capable of reducing as much as possible the time taken until an image is first displayed after inputted video data has changed, wherein, when video data inputted into an input device changes, a decode timing generating device generates a decode timing signal at a point in time when a decodable frame that can be decoded is first acquired after the change, and a display timing generating device generates a display timing signal at a point in time when a displayable frame that can be displayed is first acquired after the change.

### BACKGROUND OF THE INVENTION

1. Field of the Invention

The present invention relates to a video display apparatus and, more specifically, to a video display apparatus for displaying an image of a digital broadcast program.

2. Description of the Background Art

In broadcasting by means of digital broadcast programs, digital compression techniques such as moving picture experts group (MPEG)-2 and MPEG-4 have been employed. In a television receiver (hereinafter also referred to as “television”) that receives a digital broadcast, a broadcast signal, transmitted with transmission data and in conditions which are regulated by the broadcasting standard and operations, is received and the received signal is decoded in specified conditions, to display an image of a program. Therefore, there has been a problem in that the time taken from when a television viewer performs a channel-select operation to when an image of program of the selected channel is displayed on a television display screen is long, and a long time is thus required until an image is outputted after selection of a channel, as compared with the case the analog broadcasting.

As a remedial measure for such a problem, a digital broadcast receiver has been proposed which outputs another image during the time until an image of a program of a selected channel is outputted, so as to alleviate a psychological load of the user (e.g. see Japanese Patent Application Laid-Open No. 2005-295028). Further, though not being a technique related to the digital broadcasting, a multiplexed data divider has been proposed which is configured to compare data indicating decode start timing in a video decoder with data indicating times, and write video data into a video code buffer at a higher transmission rate than designated in a bit stream in a manner corresponding to a result of the comparison, so as to improve the responsiveness at the start of playback (e.g. see Japanese Patent Application Laid-Open No. H06-333341).

Even in the case of inserting another image during the time until an image of a program of a selected channel is outputted as the foregoing technique disclosed in Japanese Patent Application Laid-Open No. 2005-295028, the time taken until a desired program is watched cannot be reduced. Further, the foregoing technique disclosed in Japanese Patent Application Laid-Open No. H06-333341 is a technique for advancing timing for an image output of an already recorded program, which cannot make earlier an image output of a program of a channel selected in selection of a channel of a broadcast program, thereby preventing reduction in time until an image is outputted.

As thus described, even with use of the technique disclosed in Japanese Patent Application Laid-Open No. 2005-295028 or Japanese Patent Application Laid-Open No. H06-333341, the time until an image of a program of a selected channel is outputted cannot be reduced, causing the problem of low convenience for the user.

### SUMMARY OF THE INVENTION

An object of the invention is to provide a video display apparatus capable of reducing as much as possible the time taken until an image is first displayed after inputted video data has changed, such as the time from channel selection to output of an image of a program of the selected channel.

A video display apparatus of the present invention decodes video data that includes a plurality of coded frames and displays the decoded data. The video display apparatus includes an input device, a decode timing generating device, a decode device, a display timing generating device, and an output device.

The video data is inputted into the input device. The decode timing generating device generates a decode timing signal that indicates decode timing at which each frame of the video data inputted into the input device is decoded. The decode device decodes each frame of the video data inputted into the input device based upon the decode timing signal. The display timing generating device generates a display timing signal that indicates display timing at which each frame decoded by the decode device is outputted. The output device outputs each decoded frame based upon the display timing signal.

When the video data inputted into the input device changes, the decode timing generating device generates the decode timing signal at a point in time when a decodable frame that can be decoded is first acquired after the change. When the video data inputted into the input device changes, the display timing generating device generates the display timing signal at a point in time when a displayable frame that can be displayed is first acquired after the change.

According to the video display apparatus, it is possible to reduce the time taken until an image is first displayed after video data inputted into the input device has changed. Therefore, the time from channel selection to output of an image of a program of the selected channel can be reduced as much as possible.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a video display apparatus 1 in a first embodiment of the present invention;

FIG. 2 is a flowchart showing a processing procedure of a decode timing generating section 14 concerning decode timing generation processing in the first embodiment of the present invention;

FIG. 3 is a flowchart showing a processing procedure of a display timing generating section 17 concerning display timing generation processing in the first embodiment of the present invention;

FIGS. 4A to 4D are views each schematically showing display timing of frames based upon an operation of the display timing generating section 17 in the first embodiment of the present invention;

FIG. 5 is a flowchart showing a processing procedure of a decode timing generating section concerning decode timing generation processing in a conventional technique;

FIG. 6 is a flowchart showing a processing procedure of a display timing generating section concerning display timing generation processing in the conventional technique;

FIG. 7 is a flowchart showing a processing procedure of the decode timing generating section 14 concerning decode timing generation processing in a second embodiment of the present invention;

FIG. 8 is a flowchart showing a processing procedure of the display timing generating section 17 concerning display timing generation processing in the second embodiment of the present invention;

FIGS. 9A to 9D are views each schematically showing display timing of frames based upon an operation of the display timing generating section 17 in a third embodiment of the present invention;

FIGS. 10A to 10D are views each schematically showing display timing of frames based upon an operation of the display timing generating section 17 in a fourth embodiment of the present invention;

FIG. 11 is a flowchart showing a processing procedure of the decode timing generating section 14 concerning decode timing generation processing in a fifth embodiment of the present invention; and

FIGS. 12A and 12B are views each schematically showing the relation among an accumulation amount of a decode buffer 13, the decode timing and the display timing.

### DESCRIPTION OF THE PREFERRED EMBODIMENTS

### First Embodiment

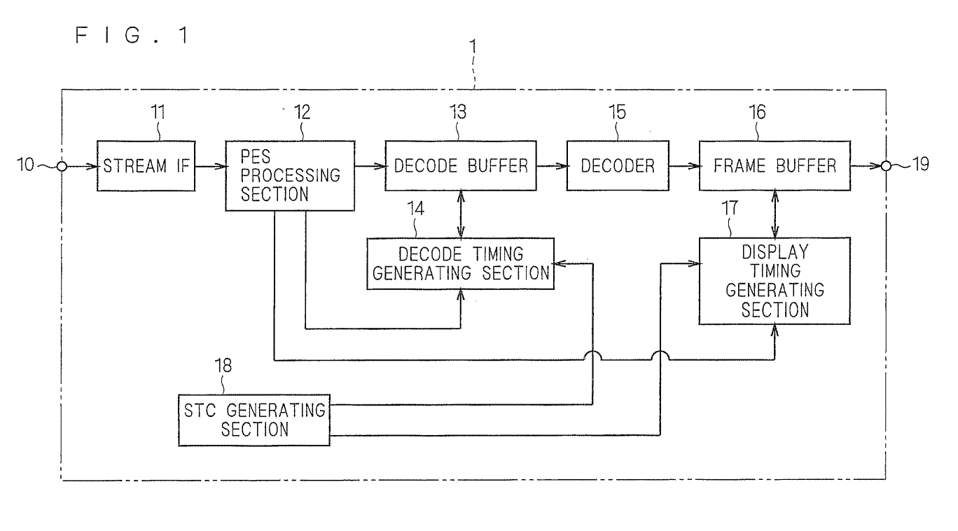

FIG. 1 is a block diagram showing a configuration of a video display apparatus 1 in a first embodiment of the present invention. The video display apparatus 1 is configured including an input terminal 10, a stream interface (IF) 11, a packetized elementary stream (PES) processing section 12, a decode buffer 13, a decode timing generating section 14, a decoder 15, a frame buffer 16, a display timing generating section 17, a system time clock (STC) generating section 18, and an output terminal 19. The input terminal 10 corresponds to the input device, the decode timing generating section 14 corresponds to the decode timing generating device, the decoder 15 corresponds to the decode device, the display timing generating section 17 corresponds to the display timing generating device, and the output terminal 19 corresponds to the output device.

Into the input terminal 10, for example, video data is inputted which is transmitted from a broadcast station and included in a digital broadcast signal received by a reception antenna, not shown. The video data inputted into the input terminal 10 includes a plurality of frames, and are inputted into the stream IF 11 in units of frames.

The stream IF 11 pulls a PES packet from the inputted video data, and gives the data to the PES processing section 12. The PES packet is data obtained by packetizing a compressed and coded image. An image is stored into a PES packet by units of decoding and reproduction. The PES packet serves as a unit for performing time management of media reproduction.

The PES packet is divided into payloads of a plurality of transport stream (TS) packets having the same packet identification (PID) number, and then transmitted. The TS consists of TS packets with a fixed length of 188 bytes, and is used in a real-time transmission/communication system including the digital broadcasting. Each TS packet has a header section with a fixed length of 4 bytes, and a payload section made up of the remaining 184 bytes. The header section includes the PID so as to make the packet identifiable.

The PES processing section 12 analyzes information included in the header section of the PES given from the stream IF 11, to give the information to the decode timing generating section 14 and the display timing generating section 17, and also give payload data to the decode buffer 13.

The STC generating section 18 gives to the decode timing generating section 14 and the display timing generating section 17 a STC generated using a program clock reference (PCR) included in the TS or a system clock reference (SCR) included in the PES. Here, the STC is a reference value of a time for synchronizing an image or a sound, the PCR is data showing a time on a program, and the SCR is data showing a time on a stream.

The decode timing generating section 14 generates a decode timing signal indicating decode timing by the decoder 15 based upon information included in the PES packet given from the PES processing section 12, and also give the generated decode timing signal to the decode buffer 13. Further, more specifically speaking, when video data inputted into the input terminal 10 changes, the decode timing generating section 14 generates the decode timing signal at a point in time when a decodable frame that can be decoded is first acquired after the change, which is a point in time when the whole of the decodable frame is acquired in the present embodiment. The change in video data inputted into the input terminal 10 includes the start of inputting of a video stream into the input terminal 10.

The decode buffer 13 temporarily stores the payload data given from the PES processing section 12, and analyzes data in and under the PES layer. The decode buffer 13 then gives the video data to the decoder 15 in line with the decode timing indicated by the decode timing signal given from the decode timing generating section 14. When given the video data from the decode buffer 13, the decoder 15 decodes the given video data, and gives the decoded data to the frame buffer 16.

Based upon information included in the PES packet given from the PES processing section 12, the display timing generating section 17 generates a display timing signal indicating timing for outputting the video data from the frame buffer 16 and displaying the data in a display section, not shown, and gives the generated display timing signal to the frame buffer 16.

The frame buffer 16 temporarily stores the decoded data given from the decoder 15, and outputs the decoded data from the output terminal 19 to the display section, not shown, in line with the display timing indicated by the display timing signal given from the display timing generating section 17. Thereby, the image is displayed in the display section.

FIG. 2 is a flowchart showing a processing procedure of the decode timing generating section 14 concerning decode timing generation processing in the first embodiment of the present invention. In the flowchart shown in FIG. 2, a case is assumed where the video display apparatus 1 of the present embodiment is adjusted to a television receiver, and when an input of the video data into the stream IF 11 is started immediately after turning-on of power to the television receiver, or when a broadcast channel is switched by an operation of the user or by some other means to change the type, state, and the like of the input stream into the stream IF 11, the present processing is started, and moves to step a1.

In step a1, the decode timing generating section 14 determines whether or not the decodable frame as a frame capable of decoding the whole frame is present, namely whether or not the decodable frame has been acquired through the stream IF 11. The decode timing generating section 14 determines whether or not the decodable frame is present based upon information included in the PES packet given from the PES processing section 12.

Specifically speaking, when a frame that is coded without use of inter-frame prediction, such as a frame to be a later-mentioned I frame (Intra-coded Frame), is inputted into the stream IF 11, the whole frame can be decoded only by video data concerning that frame, and hence the decode timing generating section 14 determines the presence of the decodable frame.

When a frame that is coded with use of the inter-frame prediction is inputted into the stream IF 11, the whole frame cannot be decoded only by video data concerning that frame, and hence the decode timing generating section 14 determines whether or not the decodable frame is present based upon whether or not another frame for use in coding of that frame has been inputted. When another frame for use in coding of that frame was inputted before inputting of the frame to be coded with use of the inter-frame prediction, the whole frame can be decoded, and hence the decode timing generating section 14 determines the presence of the decodable frame. When another frame for use in coding of that frame was not inputted., the whole frame cannot be decoded, and hence the decode timing generating section 14 determines the absence of the decodable frame when determining that the frame was not the decoclable frame.

Further specifically speaking, in the present embodiment, in step a1, the decode timing generating section 14 determines whether or not the decodable frame is present based upon whether or not the whole of the decodable frame has been acquired, more specifically whether or not the whole of the video data concerning the decodable frame has been acquired. The decode timing generating section 14 determines the presence of the decodable frame when determining that the whole of the decodable frame has been acquired, and determines the absence of the decodable frame when determining that the whole of the decodable frame has not been acquired. When the presence of the decodable frame is determined in step a1, the processing moves to step a2, and when the absence of the decodable frame is determined, the processing stands by until the presence of the decodable frame is determined.

In step a2, the decode timing generating section 14 generates a decode timing signal indicating decode timing by the decoder 15, and gives the signal to the decode buffer 13. After completion of the processing of step a2, all the processing procedure is completed.

As thus described, according to the present embodiment, the decode timing generating section 14 generates a decode timing signal when determining the presence of a decodable frame in accordance with the flowchart shown in FIG. 2. The processing of the flowchart shown in FIG. 2 is started upon change in video data inputted into the input terminal 10, and when the acquirement of the decodable frame is determined in step a1, the processing moves to step a2. More specifically, when it is determined that the whole of the decodable frame has been acquired in step a1, the processing moves to step a2. In other words, when video data inputted into the input terminal 10 changes, the decode timing signal is generated at a point in time when a decodable frame that can be decoded is first acquired after the change, which is a point in time when the whole of the decodable frame is acquired in the present embodiment. Therefore, the decode timing generating section 14 generates a decode timing signal at timing for detecting a first frame, the whole of which can be decoded immediately after the input stream into the stream IF 11 has changed, such as a frame being a first I frame from a first detected sequence header in the case of sequence headers having been inserted in group of picture (GOP) units.

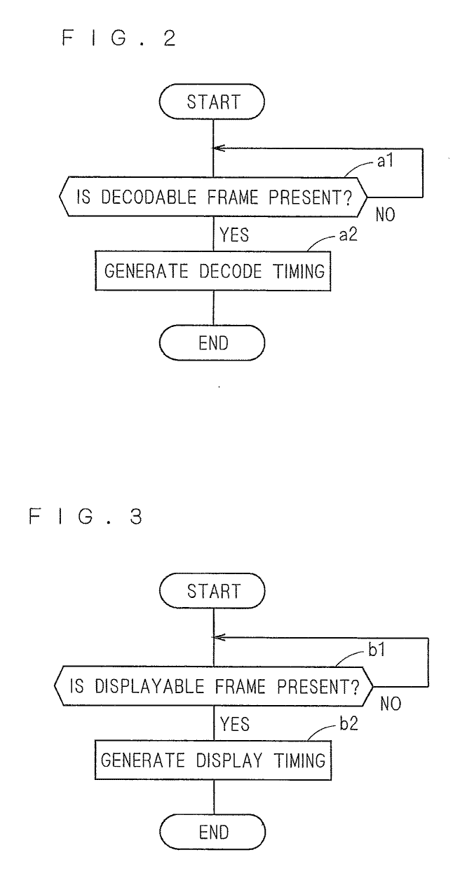

FIG. 3 is a flowchart showing a processing procedure of the display timing generating section 17 concerning display timing generation processing in the first embodiment of the present invention. Similarly to the flowchart shown in FIG. 2, also in the flowchart shown in FIG. 3, a case is assumed where the video display apparatus 1 of the present embodiment is adjusted to the television receiver, and when an input of the video data into the stream IF 11 is started immediately after turning-on of power to the television receiver, or when a broadcast channel is switched by an operation of the user or by sonic other means to change the type, state, and the like of the input stream into the stream IF 11, the present processing is started, and moves to step b1.

In step b1, the display timing generating section 17 determines whether or not a displayable frame as a frame that can be displayed is present. The display timing generating section 17 determines whether or not the displayable frame is present based upon information included in the PES packet given from the PES processing section 12. Specifically, when detecting that data outputted from the decoder 15 and stored into the frame buffer 16 has come into a displayable state, namely that decoding has been completed and the order of display has become the same as that of the original image, the display timing generating section 17 determines the presence of the displayable frame. When the presence of the displayable frame is determined in step b1, the processing moves to step b2, and when the absence of the displayable frame is determined, the processing stands by until the presence of the displayable frame is determined.

In step b2, the display timing generating section 17 generates a display timing signal indicating display timing, and gives the signal to the frame buffer 16. After completion of the processing of step b2, all the processing procedure is completed.

As thus described, in the present embodiment, in accordance with the flowchart shown in FIG. 3, the display timing generating section 17 detects that data outputted from the decoder 15 and stored into the frame buffer 16 has come into a displayable state, namely that decoding has been completed and the order of display has become the same as that of the original image, and then generates the display timing signal. Thereby, the display timing signal is generated at timing when decoding has been completed and the order of display becomes the same as that of the original image. For example, first displayable timing after the change in stream is timing at which decoding of the first I frame after the change in stream is completed, namely timing at which all data concerning the first I frame after the change in stream is decoded, and the display timing signal is generated at this timing.

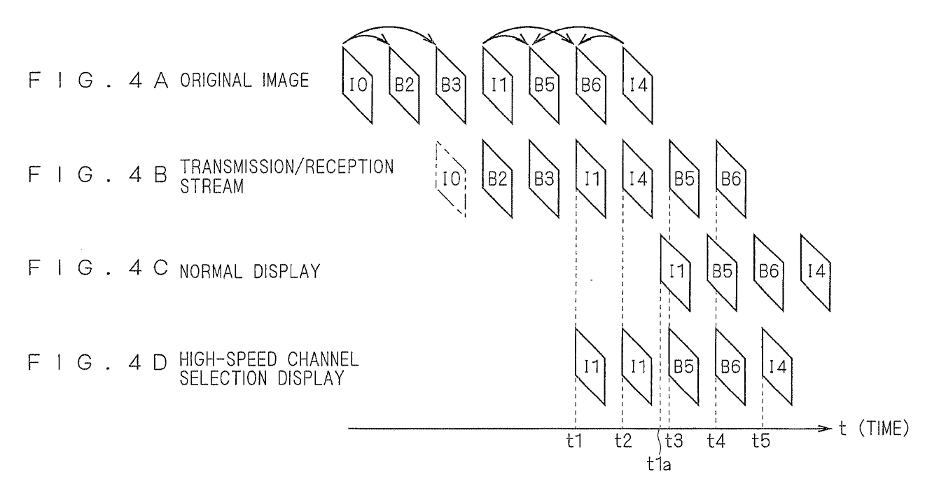

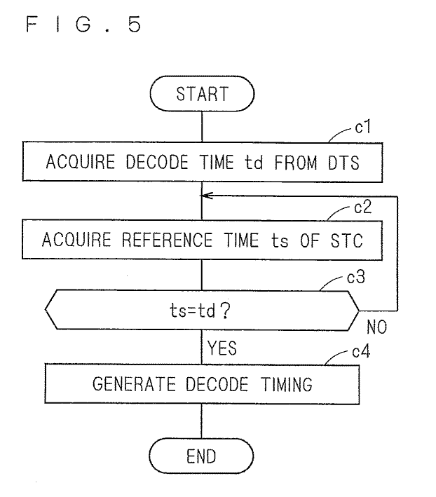

FIGS. 4A to 4D are views each schematically showing display timing of frames based upon an operation of the display timing generating section 17 in the first embodiment of the present invention. In FIGS. 4A to 4D, the order of frames in the original image and the order of frames in the transmission/reception stream, are shown simultaneously. Further, in FIGS. 4A to 4D, display timing of frames according to the conventional technique are shown as a “normal display”, and display timing of frames according to the present embodiment are shown as a “high-speed channel selection display”. FIG. 4A represents frames in the original image, FIG. 4B represents frames in the transmission/reception stream, FIG. 4C represents frames in the normal display, and FIG. 4D represents frames in the high-speed channel selection display. In FIGS. 4A to 4D, in order to facilitate the understanding, delays such as an encode delay, a transmission delay, and a decode delay are expressed as zero. Further, each delay and processing time are considered as being free of fluctuations.

In FIGS. 4A to 4D, Ix (x is a positive integer) represents an I frame, and Bx (x is a positive integer) represents a B frame (Bi-directional Predicted Frame). The I frame is a frame coded without use of the inter-frame prediction, and the B frame is a frame coded with use of the inter-frame prediction, as well as a frame coded by selecting any of a forward-directional prediction, a backward-directional prediction, and a bi-directional prediction.

In the present embodiment, it is assumed that frames B2 and B3 are frames generated by predicted conversion using frames I0, and frames B5 and B6 are frames generated by predicted conversion using frames I1 and I4. When the original image is in order of I0, B2, B3, I1, B5, B6 and I4 as shown in FIG. 4A, the transmission stream is in order of I0, B2, B3, I1, I4, B5 and B6. At this time, when the reception stream cannot acquire the frame I0 shown by a chain double-dashed line and receives the transmission stream from B2 and afterward in FIGS. 4A to 4D, since B2 and B3 cannot be decoded, decodable and displayable frames are I1, B5, B6 and 14. That is, a first decodable frame after the start of stream reception is I1.

Therefore, in foregoing step al of FIG. 2, the timing at which the presence of the decodable frame is determined by the decode timing generating section 14 is a time t1. With the delay due to decoding in the subsequent decoder 15 regarded as zero, in foregoing step b1 of FIG. 3, the timing at which the presence of the displayable frame is determined by the display timing generating section 17 is also the time t1.

A frame to be made decodable next is I4, and while decodable timing of this frame I4 is a time t2, displayable timing therefor is a time t5 in accordance with the order of the original image. Timing at which a frame to be displayed next to the frame I1 become decodable, as well as displayable timing after decoding, is a time t3, and timing at which a frame to be displayed third from the frame I1 becomes decodable, as well as displayable timing after decoding, is time t4.

On the other hand, in the case of performing decoding and displaying according to the conventional technique, namely in the case of performing decoding and displaying without application of the present embodiment, the decode timing of each frame is a time shown by decoding time stamp (DTS) having been inserted inside the PES header, and the display timing of each frame is a time shown by presentation time stamp (PTS) having been inserted inside the PES header. Therefore, as shown in FIG. 4C, timing at which the frame I1 is finally displayed is a time t1a shown by the PTS.

FIG. 5 is a flowchart showing a processing procedure of a decode timing generating section concerning decode timing generation processing in the conventional technique. FIG. 5 corresponds to the flowchart showing the processing procedure of the decode timing generating processing in the normal display shown in FIG. 4C.

In step c1, the decode timing generating section acquires a decode time td from the DTS. When the decode time td is acquired by the decode timing generating section in step c1, the processing moves to step c2.

In step c2, the decode timing generating section acquires a reference time ts of the STC. When the reference time ts of the STC is acquired by the decode timing generating section in step c2, the processing moves to step c3.

In step c3, the decode timing generating section determines whether or not the reference time ts and the decode time td agree with each other. When the agreement between the reference time ts and the decode time td (ts=td) is determined in step c3, the processing moves to step c4, and when the disagreement between the reference time ts and the decode time td is determined, the processing returns to step c2, followed by performance of processing similar to the foregoing processing. That is, the decode timing generating section stands by until the reference time ts becomes the decode time td.

In step c4, the decode timing generating section generates a decode timing signal and gives the signal to the decode buffer. After completion of the processing of step c4, all the processing procedure is completed. In such a manner, in the conventional technique, the decode timing signal is generated at the decode time td shown by the DTS having been inserted inside the PES header.

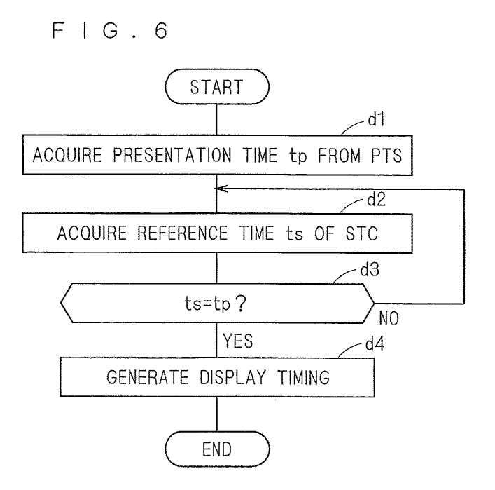

FIG. 6 is a flowchart showing a processing procedure of a display timing generating section concerning display timing generation processing in the conventional technique. FIG. 6 corresponds to a flowchart showing the processing procedure of the display timing generating processing in the normal display shown in FIG. 4C.

In step d1, the display timing generating section acquires a presentation time tp from the PTS. When the presentation time tp is acquired by the display timing generating section in step d1, the processing moves to step d2.

In step c12, the display timing generating section acquires the reference time ts of the STC. When the reference time ts of the STC is acquired by the display timing generating section in step d2, the processing moves to step d3.

In step d3, it is determined whether or not the reference time ts and the presentation time tp agree with each other. When the agreement between the reference time ts and the presentation time tp (ts=tp) is determined in step d3, the processing moves to step d4, and when the disagreement between the reference time ts and the presentation time tp is determined, the processing returns to step d2, followed by performance of processing similar to the foregoing processing. That is, the display timing generating section stands by until the reference time ts becomes the presentation time tp.

step d4, the display timing generating section generates a display timing signal, and gives the signal to the frame buffer. After completion of the processing of step d4, all the processing procedure is completed. As thus described, in the conventional technique, the display timing signal is generated at the presentation time tp shown by the PTS having been inserted inside the PES header. For example, as shown in FIG. 4C described above, timing at which the frame I1 is displayed is the time t1a as the presentation time shown by the PTS. In other words, in the conventional technique, even when the first frame after the change in stream has comes into a displayable state before the presentation time t1a shown by the PTS, it is not displayed until the presentation time t1a shown by the PTS. Therefore, the time from starting or changing of the video stream to displaying of an image is long as compared with the case of the high-speed channel selection display according to the present embodiment shown in FIG. 4D.

As thus described, according to the present embodiment, when video data inputted into the input terminal 10 changes, a decode timing signal is generated at a point in time when a decodable frame is first acquired after the change, specifically at a point in time when the whole of the decodable frame is acquired and the display timing signal is generated at a point in time when the displayable frame is acquired. In other words, in the present embodiment, when the presence of the decodable frame in the reception stream is determined, the decode timing signal is immediately generated regardless of the DTS, to decode the decodable frame. Further, when the presence of the displayable frame is determined, the display timing signal is immediately generated regardless of the PTS, to display the displayable frame. In such a manner, in the present embodiment, the decodable frame that arrives first in the reception stream is immediately decoded, and further, data after decoding is immediately displayed.

It is thereby possible to reduce the time after the change in video stream as video data inputted into the input terminal 10 until an image is displayed. It is therefore possible to reduce as much as possible the time from selection of a channel of a digital broadcast to outputting of an image of the program of the selected channel. In other words, it is possible in a switching display at the time of channel selection to reduce the time until an image after the switching is displayed.

Further, in the present embodiment, since the display timing of the frame is set not in decoded order but in order of the original image, it is possible to display an image free of fluctuations.

As thus described, while the method for generating decode timing and display timing in units of frames was described in the present embodiment, the unit is not restricted to the frame, and even in units of fields or pictures, the method can be suitably implemented in a similar manner to the present embodiment.

### Second Embodiment

Next described is a video display apparatus of a second embodiment of the present invention. While the description was given in the foregoing first embodiment on the assumption that the video stream data does not fluctuate and the time required for the processing inside the video display apparatus 1 is zero, in the present embodiment, a video display apparatus also in consideration of the fluctuations and processing delay is described. Since the video display apparatus of the present embodiment is identical to the video display apparatus 1 of the foregoing first embodiment except for differences in decode timing generating processing and display timing generating processing, the different portions are described and the common descriptions are not given.

In the present embodiment, the decode timing generating section 14 generates a decode timing signal indicating decode timing by the decoder 15 based upon information included in the header section of the PES packet given from the PES processing section 12 and the STC given from the STC generating section 18, and gives the generated decode timing signal to the decode buffer 13.

Further, the display timing generating section 17 generates a display timing signal indicating timing for outputting video data from the frame buffer 16 to display the data in the display section, not shown, based upon information included in the header section of the PES given from the PES processing section 12 and the STC given from the STC generating section 18, and gives the generated display timing signal to the frame buffer 16.

FIG. 7 is a flowchart showing a processing procedure of the decode timing generating section 14 concerning decode timing generation processing in the second embodiment of the present invention. Immediately after the start of the decode timing generating processing, the processing in accordance with the flowchart shown in FIG. 2 is performed as in the case of the first embodiment. However, in step a2 shown in FIG. 2, the decode timing generating section 14 generates a decode timing signal, and previously acquires a decode time td0 shown by the DTS of the first decodable frame and an actual decode timing time tc0. Subsequently, the decode timing generating processing on second and subsequent frames are performed in accordance with the processing procedure of the flowchart shown in FIG. 7, which is described below. In other words, upon completion of all the processing procedure of the flowchart shown in FIG. 2, the processing of the flowchart shown in FIG. 7 is started, and the processing moves to step e1.

In step e1, the decode timing generating section 14 determines whether or not the decodable frame is present. In step e1, when determining that at least part of the decodable frame has been acquired, the decode timing generating section 14 determines the presence of the decodable frame. When the presence of the decodable frame is determined in step e1, the processing moves to step e2, and when the absence of the decodable frame is determined, the processing stands by until the presence of the decodable frame is determined.

In step e2, the decode timing generating section 14 acquires the decode time td from the DTS. When the decode time td is acquired by the decode timing generating section 14 in step e2, the processing moves to step e3.

In step e3, the decode timing generating section 14 corrects the decode time td acquired in step e2 to a corrected decode time tdα obtained based upon the decode time td0 shown by the DTS of the first decodable frame and the actual decode timing time tc0, which were previously acquired. Specific correction processing is described later. When the decode time td is corrected by the decode timing generating section 14 to the corrected decode time tdα in step e3, and the processing moves to step e4.

In step e4, the decode timing generating section 14 acquires the reference time ts of the STC. When the reference time ts of the STC is acquired by the decode timing generating section 14 in step e4, the processing moves to step e5.

In step e5, the decode timing generating section 14 determines whether or not the reference time ts and the corrected decode time tdα agree with each other. When the agreement between the reference time ts and the corrected decode time tdα (ts=tdα) is determined in step e5, the processing moves to step e6, and when the disagreement between the reference time ts and the corrected decode time tdα is determined, the processing returns to step e4, followed by performance of the processing similar to the foregoing processing. That is, the decode timing generating section 14 stands by until the reference time ts becomes the corrected decode time tdα.

In step e6, the decode timing generating section 14 generates a decode timing signal, and gives the signal to the decode buffer 13. After completion of the processing of step e6, all the processing procedure is completed.

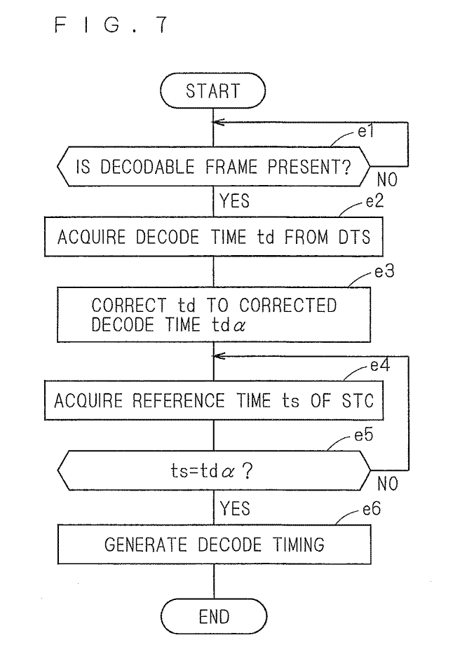

FIG. 8 is a flowchart showing a processing procedure of the display timing generating section 17 concerning display timing generation processing in the second embodiment of the present invention. Immediately after the start of the display timing generating processing, the processing in accordance with the flowchart shown in FIG. 3 is performed as in the case of the first embodiment. However, in step b2 of FIG. 3, the display timing generating section 17 generates a display timing signal, and previously acquires a presentation time tp0 shown by the PTS of the first displayable frame and a generated display timing time tq0. Subsequently, the display timing generating processing on the second and subsequent frames is performed in accordance with the processing procedure of the flowchart shown in FIG. 8, which is described below. In other words, upon completion of all the processing procedure of the flowchart shown in FIG. 3, the processing of the flowchart shown in FIG. 8 is started, and the processing moves to step f1.

In step f1, the display timing generating section 17 determines whether or not the displayable frame is present. When the presence of the displayable frame is determined in step f1, the processing moves to step f2, and when the absence of the displayable frame is determined, the processing stands by until the presence of the displayable frame is determined.

In step f2, the display timing generating section 17 acquires the presentation time tp from the PTS. When the presentation time tp is acquired by the display timing generating section 17 in step f2, the processing moves to step f3.

In step f3, the display timing generating section 17 corrects the presentation time tp acquired in step f2 to a corrected presentation time tpα obtained based upon the presentation time tp0 shown by the PTS of the first displayable frame and the generated display timing time tq0, which were previously acquired. Specific correction processing is described later. When the presentation time tp is corrected by the display timing generating section 17 to the corrected presentation time tpα in step f3, the processing moves to step f4.

In step f4, the display timing generating section 17 acquires a reference time ts of the STC. When the reference time ts of the STC is acquired by the display timing generating section 17 in step f4, the processing moves to step f5.

In step f5, the display timing generating section 17 determines whether or not the reference time ts and the corrected presentation time tpα agree with each other. When the agreement between the reference time ts and the corrected presentation time tpα (ts=tpα) is determined in step f5, the processing moves to step f6, and when the disagreement between the reference time ts and the corrected presentation time tpα is determined, the processing returns to step f4, followed by performance of the processing similar to the foregoing processing. In other words, the display timing generating section 17 stands by until the reference time ts becomes the corrected presentation time tpα.

In step f6, the display timing generating section 17 generates a display timing signal, and gives the signal to the frame buffer 16. After completion of the processing of step f6, all the processing procedure is completed.

As thus described, in the present embodiment, as for the second and subsequent frames, the decode timing generating section 14 generates a decode timing signal at a point in time when the reference time ts shown by the STC becomes the corrected decode time tdα obtained by correcting the decode time td shown by the DTS, based upon information included in the header section of the PES packet given from the PES processing section 12 and the STC given from the STC generating section 18. Further, the display timing generating section 17 generates the display timing signal at a point in time when the reference time ts shown by the STC becomes the corrected presentation time tpα obtained by correcting the presentation time tp shown by the PTS, based upon information included in the header section of the PES packet given from the PES processing section 12 and the STC given from the STC generating section 18.

Therefore, even when video stream data inputted into the video display apparatus fluctuates, or even when the processing from inputting of an image to displaying thereof is not a fixed delay, it is possible to display an image free of disturbance.

Further, in the present embodiment, since the timing correction is performed both at the decode timing and the display timing, even when the processing is to stand by until decoded data is displayed, the standby time is short, and hence a buffer amount for display can be made small.

Next, the timing generation correcting processing is described. In the present embodiment, the corrected decode time tdα as the corrected value of the DTS for decode timing is calculated by the following equation (1), using the decode time td0 shown by the DTS of the first decodable frame and the actual decode timing time tc0:

tdα=td−(td0−tc0) (1)

where “td0−tc0” represents an amount of displacement of the actual decode timing time tc0 from the decode time td0 shown by the DTS in the first decodable frame.

Further, the corrected presentation time tpα as the corrected value of the PTS for display timing is calculated by the following equation (2), using the presentation time tp0 shown by the PTS of the first displayable frame and the generated display timing time tq0:

tpα=tp−(tp0−tq0) (2)

where “tp0 tq0” represents an amount of displacement of the actually generated display timing time tq0 from the presentation time tp0 shown by the PTS in the first displayable frame.

The correction based upon the equation (1) and the correction based upon the equation (2) are referred to as “linear correction” in the following description.

As thus described, in the present embodiment, based upon the first decode and display timing, decode and display timing of the second and subsequent frames are subjected to the linear correction. In other words, with the decode and display timing of the second and subsequent frames displaced by an amount corresponding to a displacement amount of the first decode and display timing, the decode timing signal and the display timing signal are generated.

This allows display of the frames at the same intervals as the frame intervals of the original image. Therefore, the time from starting or changing of the inputted video stream to displaying of the first image can be made earlier as in the case of the first embodiment, and also the frames can be displayed at the same intervals as the frame intervals of the original image. While the method for correcting both the decode timing and the display timing was described in each of the foregoing first and second embodiments, a method for correcting either timing can also be implemented in a case where the buffer amount involved in each of decoding and displaying is sufficient.

### Third Embodiment

While the linear correction was used as the correction method in the timing generation in the foregoing second embodiment, another correction method is adopted in a third embodiment of the present invention. A video display apparatus of the present embodiment is similar to the video display apparatus of the second embodiment except for the correction method in the timing generation.

Correction processing in timing generation in the present embodiment is described. The processing until generation of the first decode timing and display timing is performed in a similar manner to the second embodiment. Subsequently, the processing stands by until decode timing as a second one becomes equivalent to a time designated by input video data, namely the decode time td shown by the DTS. That is, the correction equation is the following equation (3):

tdα=td (3)

Further, the processing stands by until the display timing as the second one becomes equivalent to a time designated by the input video data, namely the presentation time tp shown by the PTS. That is, the correction equation is the following equation (4):

tpα=tp (4)

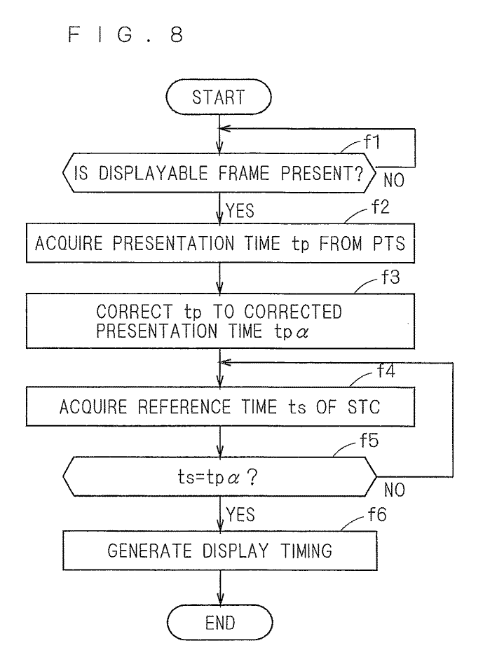

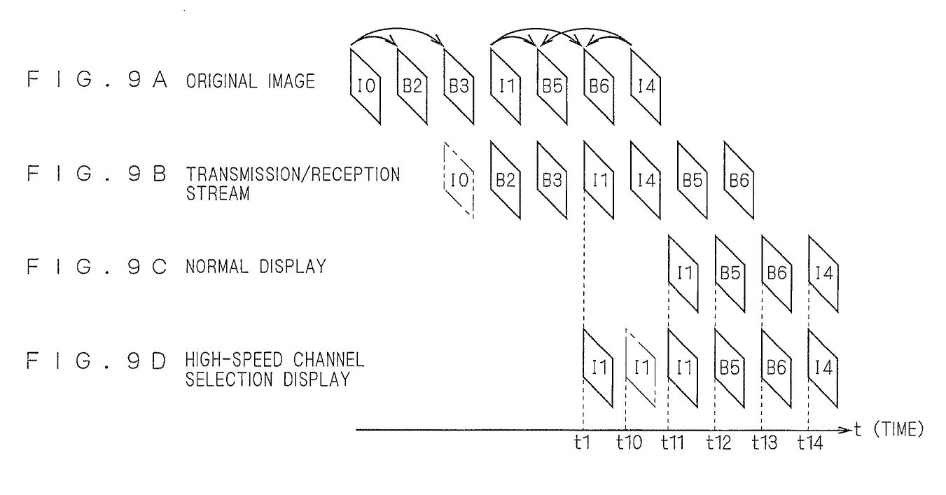

FIGS. 9A to 9D are views each schematically showing display timing of frames based upon an operation of the display timing generating section 17 in the third embodiment of the present invention. In FIGS. 9A to 9D, as in FIGS. 4A to 4D, the order of frames in the original image and the order of frames in the transmission/reception stream are shown simultaneously. Further, in FIGS. 9A to 9D, display timing of frames according to the conventional technique are shown as the “normal display”, and display timing of frames according to the present embodiment are shown as the “high-speed channel selection display”. FIG. 9A represents frames in the original image, FIG. 9B represents frames in the transmission/reception stream, FIG. 9C represents frames in the normal display, and FIG. 9D represents frames in the high-speed channel selection display. In FIGS. 9A to 9D, in order to facilitate the understanding, delays such as the encode delay, the transmission delay, and the decode delay are expressed as zero. Further, each delay and processing time are considered as being free of fluctuations.

Similarly to the foregoing case shown in FIGS. 4A to 4D, when the frame I0 shown by a chain double-dashed line cannot be acquired and the transmission stream from B2 and afterward is received, the first decodable frame and displayable frame after the start of the stream reception are I1. The decode timing of this first decodable frame I0 and the display timing of the first displayable frame I0 are the time t1 also in the present embodiment.

In the present embodiment, the processing stands by during the time from the first decode timing and display timing to the next decode and display timing until the time designated by the input video data. Specifically speaking, as shown in FIG. 9D, the decodable timing of the second decodable frame I4 is not the time t2 shown in FIGS. 4A to 4D as the time when the frame becomes displayable, but the decode time shown by the DTS of the decodable frame I1, and the displayable timing is the presentation time t14 shown by the PTS.

The decodable timing of the third decodable frame B5 is a decode time t12 shown by the DTS, and when assuming that the delay is zero, the displayable timing is also the presentation time t12 defined by the PTS. That is, in the present embodiment, after the first displayable frame I0 has been displayed at the time t1, a display in GOP units starting from the frame I0 is started from the presentation time t11 shown by the PTS of the first displayable frame I0.

As compared with the foregoing first embodiment shown in FIGS. 4A to 4D, in the first embodiment, the display in GOP units starting from the frame I0 is started at the time t2 between the time t1 when the first displayable frame I0 is displayed and the presentation time t1a shown by the PTS of the first displayable frame I0. As opposed to this, in the present embodiment, the display in GOP units is not started at a time t10 between the time t1 when the first displayable frame I0 is displayed and the presentation time t11 shown by the PTS of the first displayable frame I0, but is started at the presentation time t11 shown by the PTS.

As thus described, the processing stands by until the time designated by the input video data during the time from the first decode and display timing to the next decode and display timing, and thereby the frame can be displayed at the time designated by the input video data when the next frame is displayed. Further, since the display timing of the second and subsequent frames is the presentation time tp designated by the input video data, the frames can be displayed at the same intervals as the frame intervals of the original image.

Therefore, similarly to the first and second embodiments, it is possible to reduce the time from starting or changing of the input video streams to displaying of the first image, and also to display the second and subsequent frames at the same intervals as the frame intervals of the original image at the time designated by the input video data.

### Fourth Embodiment

In a fourth embodiment of the present invention, a correction method different from those in the second and third embodiments is adopted. The video display apparatus of the present embodiment is similar to those of the second and third embodiments except for the correction method in the timing generation.

Correction processing in timing generation in the present embodiment is described. The processing until generation of the first decode timing and display timing is performed in a similar manner to the case of the second embodiment. The corrected decode time tdα as a corrected value of the DTS for the decode timing of the second and subsequent decodable frames is calculated by the following equation (5):

tdα=td−(td0tc0)×γ(0≦γ≦1) (5)

where “td0−tc0” represents an amount of displacement of the actual decode timing time tc0 from the decode time td0 shown by the DTS in the first decodable frame, and “γ” represents a decode time correction coefficient. In the present embodiment, the decode time correction coefficient γ shown in the equation (5) is decreased from 1 to 0 with the passage of time. Thereby, the decode timing approaches the time designated by the input video data, namely the decode time td shown by the DTS, with the passage of time.

Further, the corrected presentation time tpα as a corrected value of the PTS for the display timing of the second and subsequent displayable frames is calculated by the following equation (6):

tpα=tp−(tp0tq0)×η(0≦η≦1) (6)

where “tp0−tq0” represents an amount of displacement of the actually generated display timing time tq0 from the presentation time tp0 shown by the PTS in the first displayable frame, and “η” represents a presentation time correction coefficient. In the present embodiment, the presentation time correction coefficient η shown in the equation (6) is decreased from 1 to 0 with the passage of time. Thereby, the display timing approaches the time designated by the input video data, namely the presentation time tp shown by the PTS, with the passage of time.

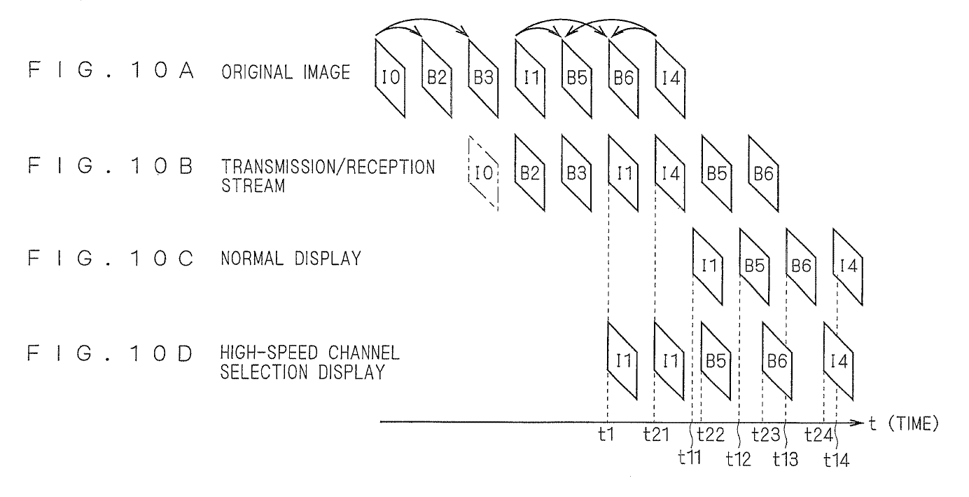

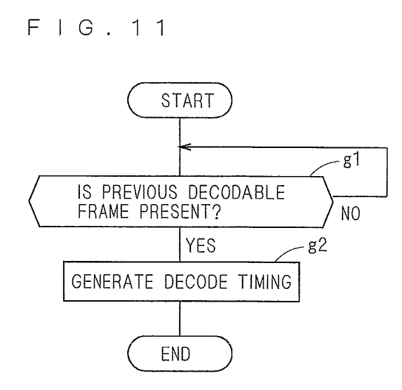

FIGS. 10A to 10D are views each schematically showing display timing of frames based upon an operation of the display timing generating section 17 in the fourth embodiment of the present invention. In FIGS. 10A to 10D, as in FIGS. 4A to 4D, the order of frames in the original image and the order of the frames in the transmission/reception stream are shown simultaneously. Further, in FIGS. 10A to 10D, display timing of frames according to the conventional technique are shown as the “normal display”, and display timing of frames according to the present embodiment are shown as the “high-speed channel selection display”. FIG. 10A represents frames in the original image, FIG. 10B represents frames in the transmission/reception stream, FIG. 10C represents frames in the normal display, and FIG. 10D represents frames in the high-speed channel selection display. In FIGS. 10A to 10D, in order to facilitate the understanding delays such as the encode delay, the transmission delay, and the decode delay are expressed as zero. Further, each delay and processing time are considered as being free of fluctuations.

Similarly to the foregoing case shown in FIGS. 4A to 4D, when the frame I0 shown by a chain double-dashed line cannot be acquired and the transmission stream from B2 and afterward is received, the first decodable frame and displayable frame after the start of the stream reception are I1. The decode timing of this first decodable frame I0 and the display timing of the first displayable frame I0 are the time t1 also in the present embodiment.

In the present embodiment, the second and subsequent decode and display timing are subjected to stepwise correction so as to approach the time when decoding or displaying should be performed. Specifically speaking, as shown in FIG. 10D, the decodable timing of the second decodable frame I4 is not a time t21 when the frame becomes decodable, but the corrected decode time tdα corrected based upon the foregoing equation (5), and the displayable timing is a time t24 as the corrected presentation time tpα corrected by the foregoing equation (6).

The decodable timing of the third decodable frame B5 is a time t22 as the corrected decode time tdα corrected based upon the foregoing equation (5), and when assuming that the delay is zero, the displayable timing is also the time t22 as the corrected presentation time corrected based upon the foregoing equation (6). In other words, in the present embodiment, after the first displayable frame I0 has been displayed at the time t1, a display in GOP units starting from the frame I0 is started from the corrected presentation time t21 corrected based upon the presentation time t1 shown by the PTS of the first displayable frame I0.

As thus described, since the decode time correction coefficient γ shown in the equation (5) and the presentation time correction coefficient η shown in the equation (6) are decreased from 1 to 0 with the passage of time, display intervals among each frame gradually increase. Specifically speaking, as shown in FIG. 10D, the interval from the time t21 to the t22, the interval from the time t22 to the time t23, and the interval from the time t23 to the time 24 gradually increase in this order.

As thus described, the second and subsequent decode and display timing are subjected to stepwise correction so as to approach a time when decoding or displaying should be performed, and thereby, similarly to the first to third embodiments, it is possible to reduce the time from starting or changing of the input video streams to displaying of the first image, and also to display an image as the time to be displayed after a lapse of a given length of time.

Further, in the present embodiment, since the second and subsequent decode and display timing are subjected to stepwise correction so as to approach the time when decoding or displaying should be performed, even during the time from displaying of the first image to displaying of an image as the time when displaying should be performed, it is possible to display an image prevented from giving an uncomfortable feeling, not to mention having disturbance.

### Fifth Embodiment

Next, a video display apparatus of a fifth embodiment of the present invention is described. Since the video display apparatus of the present embodiment is identical to the video display apparatuses of the foregoing first to fourth embodiments except for a difference in decode timing generation processing, the different portion is described and the common descriptions are not given.

In the foregoing first to fourth embodiments, when video data inputted into the input terminal 10 changes, the decode timing generating section 14 generates a decode timing signal at a point in time when the whole of the decodable frame is first acquired after the change. As opposed to this, in the present embodiment, when video data inputted into the input terminal 10 changes, the decode timing generating section 14 generates a decode timing signal at a point in time when part of the decodable frame is first acquired after the change, as well as a point in time earlier than the point in time of acquirement of the whole of the decodable frame.

FIG. 11 is a flowchart showing a processing procedure of the decode timing generating section 14 concerning decode timing generation processing in the fifth embodiment of the present invention. Similarly to the flowchart shown in FIG. 2, also in the flowchart shown in FIG. 11, the case of the video display apparatus of the present embodiment being adjusted to the television receiver is assumed, and when an input of the video data into the stream IF 11 is started immediately after turning-on of a power of the television receiver, or when a broadcast channel is switched by an operation of the user or by some other means, to change the type, state, and the like of the input stream into the stream IF 11, the present processing is started, and moves to step g1.

In step g1, the decode timing generating section 14 determines whether or not a previous decodable frame is present based upon information included in the PES packet given from the PES processing section 12. Specifically speaking, in step g1, when determining that the decodable frame is present and also that part of the decodable frame, more specifically part of the video data concerning the decodable frame, as well as data with a previously set accumulation amount, has been accumulated in the decode buffer 13, the decode timing generating section 14 determines the presence of the previous decodable frame. When determining that the decodable frame is not present, or that the decodable frame is present but the data with a set accumulation amount has not been accumulated in the decode buffer 13, the decode timing generating section 14 determines the absence of the previous decodable frame.

In the present embodiment, the set accumulation amount is selected to be a data amount sufficient for starting decoding of the decodable frame by the decoder 15, more specifically a minimum data amount required for starting decoding of the decodable frame by the decoder 15. When the presence of the previous decodable frame is determined in step g1, the processing moves to step g2, and when the absence of the previous decodable frame is determined, the processing stands by until the presence of the previous decodable frame is determined.

In step g2, the decode timing generating section 14 generates a decode timing signal, and gives the signal to the decode buffer 13. After completion of the processing of step g2, all the processing procedure is completed.

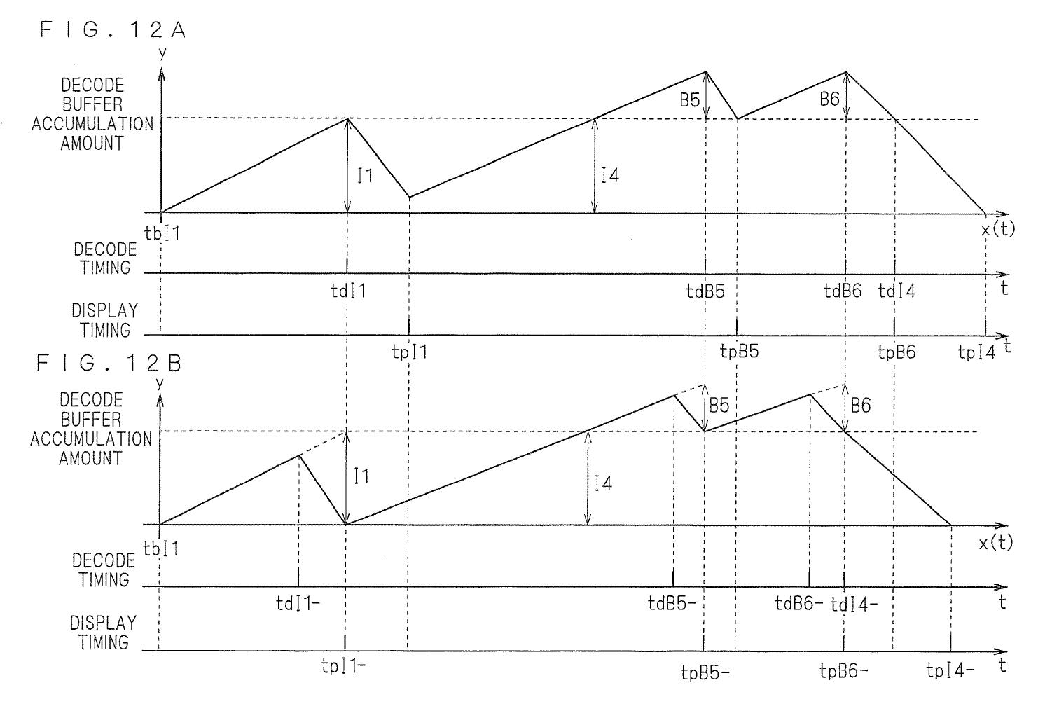

Next, the presence timing of the previous decodable frame is described. FIGS. 12A to 12D are views each schematically showing the relation among the accumulation amount of the decode buffer 13, the decode timing and the display timing. FIG. 12A is a view showing the relation among the accumulation amount of the decode buffer 13, the decode timing and the display timing in the first embodiment of the present invention, and FIG. 12B is a view showing the relation among the accumulation amount of the decode buffer 13, the decode timing and the display timing in the fifth embodiment of the present invention. In FIGS. 12A and 12B, an abscissa axis concerning the decode buffer accumulation amount represents an x-axis, and an ordinate axis represents a y-axis. Further, the x-axis and the abscissa axis concerning the decode timing and the display timing represent a time t. FIGS. 12A and 12B each show a case where a transmission/reception stream similar to the foregoing transmission/reception stream shown in FIG. 4B is transmitted/received.

First described is the presence timing of the decodable frame in the case of the first embodiment shown in FIG. 12A. As shown in FIG. 12A, data is sequentially accumulated in the decode buffer 13. Based upon information included in the PES packet given from the PES processing section 12, the decode timing generating section 14 can acquire information concerning a picture type of each frame included in the above information, such as information on whether the frame is an I frame or a B frame, at the head of picture data as data concerning that frame. Therefore, based upon the information included in the PES packet given from the PES processing section 12, the decode timing generating section 14 can determine that data of the frame I1 as the first decodable frame starts to be accumulated in the decode buffer 13 at a time tbI1, namely that a data accumulation start time is the time tbI1.

Data is accumulated in the decode buffer 13 from this time tbI1, and the data accumulation is performed until timing at which the whole of the frame I1 becomes decodable, namely a time tdI1 as timing at which accumulation of all data concerning the frame I1 is completed. When all data of the frame I1 is accumulated in the decode buffer 13 at the time tdI1, the decode timing generating section 14 determines the current timing is decode timing of the frame 11, and generates a decode timing signal. This leads to a start of outputting of data from the decode buffer 13 to the decoder 15, and a start of decoding by the decoder 15. In other words, this time tdI1 is timing at which the presence of the decodable frame is determined, namely the presence timing of the decodable frame. During the time from this decode start time tdI1 to a decode end time tpI1 of the frame I1, the decode buffer 13 continues the accumulation, and this time is a period of time when the decode buffer 13 outputs data to the decoder 15 while performing the accumulation.

Subsequently, the decode buffer 13 continues the accumulation, and accumulates data of the frame I4 as a next inputted frame. Further, the decode buffer 13 continues the accumulation, and the decode timing generating section 14 stands by until all data of the frame B5 as a frame to be outputted at next timing is accumulated in the decode buffer 13, and determines a time tdB5 that is decode timing of the frame B5. In other words, at the time tdB5, when all data of the frame B5 is accumulated in the decode buffer 13, the decode timing generating section 14 determines the current timing is the decode timing of the frame B5 and generates a decode timing signal, leading to a start of outputting of data from the decode buffer 13 to the decoder 15, and a start of decoding by the decoder 15. During the time from the decode start time tdB5 to a decode end time tpB5 of the frame B5, the decode buffer 13 continues the accumulation, and this time is a period of time when the decode buffer 13 outputs data to the decoder 15 while performing the accumulation.

Further, the decode buffer 13 continues the accumulation, and the decode timing generating section 14 stands by until data of the frame B6 as a frame to be outputted at next timing is accumulated in the decode buffer 13, and determines a time tdB6 that is decode timing of the frame B6. During the time from the decode start time tdB6 to a decode end time tpB6 of the frame B6, the decode buffer 13 continues the accumulation, and this time is a period of time when the decode buffer 13 outputs data to the decoder 15 while performing the accumulation.

Upon arrival of the decode end time tpB6 of the frame B6, the decoder 15 can start next decoding, and hence the decode timing generating section 14 generates a decode timing signal of the frame 14 as a frame to be outputted at next timing at the same time tpI4 as the decode end time tpB6 of the frame B6. During the time from the time tdI4 to a decode end time tpI4 of the frame 14, the decode buffer 13 continues the accumulation, and this time is a period of time when the decode buffer 13 outputs data to the decoder 15 while performing the accumulation.

Next described is the presence timing of the previous decodable frame in the case of the fifth embodiment shown in FIG. 12B. The determination that data accumulation starts at the time tbI1 is as in the foregoing case. Data is accumulated in the decode buffer 13 from the time tbI1, but in the present embodiment, the decode timing generating section 14 generates a decode timing signal at a time tdI1 in advance of the time tpI1 when all of data of the frame I1 to be decoded is accumulated. When it is assumed that decoding starts at the time tdI1- and ends at the time tpI1-, the time tdI1- is a time that assures accumulation of sufficient data for decoding the frame I1 in the decode buffer 13 until the time tpI1-. Specifically, as the time a time is selected when data is accumulated in the decode buffer 13 in a data amount sufficient for starting decoding of the decodable frame by the decoder 15, in the present embodiment, a minimum data amount required for starting decoding of the decodable frame by the decoder 15.

In the case of the decode time being zero, the time tpI1- is ideally a time when accumulation of all data of the frame I1 in the decode buffer 13 is completed, and is obtained as follows. First, a speed at which data is accumulated in the decode buffer 13 is linearly approximated as shown in the following equation (7):

y=ax(a>0) (7)

Further, a speed at which data is outputted from the decode buffer 13 to the decoder 15 is linearly approximated as shown in the following equation (8):

y=b(x−tdI1)(b<0) (8)

As above, when the speed at which data is accumulated in the decode buffer 13 and the speed at which data is outputted from the decode buffer 13 to the decoder 15 are linearly approximated as respectively shown in the equations (7) and (8), the x-axis at an intersection between the straight line shown in the equation (7) and the straight line shown in the equation (8) is the time tdI1-. Subsequently, in a similar manner, decode timing signals can be generated in the decode timing generating section 14 to start decoding by the decoder 15 at the times tdB5-, tdB6- and tdI4- in advance of the times tpB5-, tpB6- and tpI4- at which all data of the respective frames B5, B6, I4 are accumulated.

Therefore, in the fifth embodiment, the decode start timing of each decodable frame can be made early as compared with the first embodiment. Since this can make the decode end timing by the decoder 15 earlier, the respective frames can be displayed at the time tpI1-, tpB5-, tpB6- and tpI4- which are earlier than the display times tpI1, tpB5, tpB6 and tpI4 of the respective frames in the first embodiment.

As described above, according to the present embodiment, when video data inputted into the input terminal 10 changes, a decode timing signal is generated at a point in time when part of the decodable frame is first acquired after the change, as well as a point in time earlier than the point in time of acquirement of the whole of the decodable frame. This can make the frame displayed at earlier timing than in the foregoing first to fourth embodiments.

In the present embodiment described above, also as for each of second and subsequent frames, a decode timing signal is generated by the decode timing generating section 14 at a point in time when the presence of a previous decodable frame is determined, and a display timing signal is generated by the display timing generating section 17 at a point in time when decoding of each frame is completed. This is not restrictive, and as in the foregoing second to fourth embodiments, as for the second and subsequent frames, a decode timing signal may be generated at a point in time when the reference time ts shown by the STC becomes the corrected decode time tdα, and a display timing signal may be generated at a point in time when the reference time ts shown by the STC becomes the corrected presentation time tpα.

While the invention has been shown and described in detail, the foregoing description is in all aspects illustrative and not restrictive. It is therefore understood that numerous modifications and variations can be devised without departing from the scope of the invention.

What is claimed is:

1. A video display apparatus for decoding video data that includes a plurality of coded frames and displaying the decoded data, said apparatus comprising:
an input device, into which said video data is inputted;
a decode timing generating device for generating a decode timing signal that indicates decode timing at which each frame of said video data inputted into said input device is decoded;
a decode device for decoding each frame of said video data inputted into said input device based upon said decode timing signal;
a display timing generating device for generating a display timing signal that indicates display timing at which each frame decoded by said decode device is outputted; and
an output device for outputting said each decoded frame based upon said display timing signal,
wherein,
when said video data inputted into said input device changes, said decode timing generating device generates said decode timing signal at a point in time when a decodable frame that can be decoded is first acquired after the change, and
when said video data inputted into said input device changes, said display timing generating device generates said display timing signal at a point in time when a displayable frame that can be displayed is first acquired after the change.

2. The video display apparatus according to claim 1, wherein said point in time of the first acquirement of the decodable frame is a point in time when the whole of said decodable frame is acquired.

3. The video display apparatus according to claim 1, wherein said point in time of the first acquirement of the decodable frame is a point in time when part of said decodable frame is acquired, as well as a point in time earlier than a point in time when the whole of said decodable frame is acquired.

4. The video display apparatus according to claim 1, wherein, upon acquirement of a decodable frame after said point in time of the first acquirement of the decodable frame, said decode timing generating device generates said decode timing signal at a corrected decode time obtained by correcting a decode time previously set with respect to said acquired decodable frame.

5. The video display apparatus according to claim 1, wherein, upon acquirement of a displayable frame after said point in time of the first acquirement of the displayable frame, said display timing generating device generates said display timing signal at a corrected presentation time obtained by correcting a presentation time previously set with respect to said acquired displayable frame.

6. The video display apparatus according to claim 5, wherein said corrected presentation time is a time obtained by subtracting, from the presentation time previously set with respect to said acquired displayable frame, an amount of displacement of the time when said display timing signal with respect to said first displayable frame is generated from a presentation time previously set.

7. The video display apparatus according to claim 5, wherein said corrected presentation time is the presentation time previously set with respect to said acquired displayable frame.

8. The video display apparatus according to claim 5, wherein said corrected presentation time is selected so as to take a stepwise approach to the presentation time previously set with respect to said acquired displayable frame.
